(19) United States
(12) Patent Application Publication
(10) Pub. No.: US 2025/0368467 A1
(43) Pub. Date: Dec. 4, 2025

(54) PROCESSING DEVICE AND METHOD FOR CONTROLLING SAME

(71) Applicant: SK On Co., Ltd., Seoul (KR)

(72) Inventors: Hyeong Uk CHOI, Daejeon (KR); Ji Yun YANG, Daejeon (KR); Jun Ha CHOI, Daejeon (KR)

(21) Appl. No.: 19/183,933

(22) Filed: Apr. 21, 2025

(30) Foreign Application Priority Data
May 31, 2024 (KR) 10-2024-0071749

(51) Int. Cl. B65H 35/00; B65H 7/02; B65H 37/00; H01M 4/04

(52) U.S. Cl. CPC B65H 35/0073; B65H 7/02; B65H 37/00; H01M 4/0435; B65H 2511/22; B65H 2801/72

(57) ABSTRACT

Proposed is a processing device including a fixing pert configured to fix a member to be processed, a marking part configured to attach a mark to the member to be processed, a cutting part configured to cut the member to be processed to a predetermined length, and a controller configured to control the fixing part, the marking part, and the cutting part to be individually driven in forward and backward directions.

### CROSS REFERENCE TO RELATED APPLICATION

The present application claims priority to Korean Patent Application No. 10-2024-0071749, filed May 31, 2024, the entire contents of which is incorporated herein for all purposes by this reference.

### BACKGROUND OF THE INVENTION

### Field of the Invention

The present disclosure relates to a processing device and a method for controlling the same.

### Description of the Related Art

In general, a secondary battery is a battery that can be used repeatedly through the process of discharging that converts chemical energy into electrical energy and charging during which the chemical reactions are reversed. Various types of secondary batteries continue to be developed, such as nickel-cadmium (Ni—Cd) batteries, nickel-hydrogen (Ni-MH) batteries, lithium-metal batteries, lithium-ion (Ni-Ion) batteries, and lithium-ion polymer batteries (hereinafter referred to as “LIPB”).

Recently, secondary batteries have been attracting attention as a popular energy source as they are widely used in IT products, automobiles, and energy storage fields. In the field of IT products, secondary batteries are required to be able to be used continuously and for long stretches of time, and miniaturization and weight reduction are also important, while the automotive field requires high power, durability, and stability to eliminate explosion risks. In the energy storage field, secondary batteries are used for storing excess power produced by wind and solar generation, etc., and since a battery is used in a fixed manner, more relaxed conditions may be applied.

In the process of manufacturing a secondary battery, a product roll with electrodes wound into a roll is used to go through processes such as coating, drying, and rolling to manufacture an electrode for a secondary battery. In this case, the finishing of product rolls wound into rolls at each stage or the processing of product rolls in preparation for the next stage have a significant impact on the overall manufacturing process.

### DOCUMENT OF RELATED ART

(Patent Document 1) Korean Patent No. 10-2661995

### SUMMARY OF THE INVENTION

According to an aspect of the present disclosure, a processing device that can more effectively perform the manufacturing process of a product using a member to be processed may be provided by increasing the accuracy and efficiency of work such as cutting or sampling of the member to be processed.

According to an aspect of the present disclosure, a method for controlling a processing device may be provided to increase the reliability of the manufacturing process using a member to be processed and to ensure process efficiency by automating the cutting or sampling of the member to be processed.

A processing device according to an embodiment of the present disclosure may include: a fixing part configured to fix a member to be processed; a marking part configured to attach a mark to the member to be processed; a cutting part configured to cut the member to be processed to a predetermined length; and a controller configured to control the fixing part, the marking part, and the cutting part to be individually driven in forward and backward directions.

In this case, the fixing part may be coupled to a main body of the device at a position that is contactable with the member to be processed, the marking part may be located in a direction facing the member to be processed and coupled to the main body while being spaced apart from the fixing part, and the cutting part may be located in the direction facing the member to be processed and coupled to the main body while being spaced apart from the marking part.

In addition, the fixing part may be provided with a near roll rotatably coupled at an end thereof to contact the member to be processed and fix the member to be processed.

In addition, the device may further include at least one distance sensor configured to sense a position of the member to be processed.

In addition, the device may further include at least one detection sensor configured to sense a processing surface of the member to be processed.

In addition, the at least one detection may include: a first detection sensor coupled to a first end of the cutting part; and a second detection sensor coupled to a second end of the cutting part.

In addition, the cutting part may include: a gripper part configured to fix a part to be processed of the member to be processed; and a cutter part configured to cut a cutting area of the part to be processed fixed by the gripper part.

In addition, the gripper part may include: a pair of cylinder parts disposed at opposite ends of a main body of the device with a separation width greater than a cutting width of the part to be processed of the member to be processed; a driving part coupled to the pair of cylinder parts so that a fixing bar coupled in a direction opposite to the cutting width of the part to be processed is driven in front and rear directions of the cutting width of the part to be processed; and a support bar whose opposite ends are respectively coupled to the cylinder parts to secure the part to be processed located between the fixing bar and the support bar.

In addition, the cutting part may include: a cutter coupling part coupled to correspond to the cutting width of the part to be processed; and a cutter part coupled to a guide rail provided on the cutter coupling part along the cutting width of the part to be processed to cut the part to be processed.

A method for controlling a processing device according to an embodiment of the present disclosure may include: detecting a tape connection portion of a member to be processed; supplying, when the tape connection portion of the member to be processed is detected, a part to be processed including the tape connection portion of the member to be processed; fixing, by the fixing part, the member to be processed when the supply of the part to be processed is completed; and cutting, by the cutting part, the tape connection portion of the part to be processed.

In this case, the method may further include: checking, after the step of cutting, by the cutting part, the tape connection portion of the part to be processed of the member to be processed, whether sampling work for the member to be processed is necessary; fixing, by the fixing part, the member to be processed when the sampling work for the member to be processed is not necessary; determining whether tape work is necessary for the member to be processed; and attaching, by the marking part, a tape to a corresponding position of the member to be processed when the tape work is necessary for the member to be processed.

In addition, the method may further include: recognizing, after the step of attaching the tape by the marking part to the corresponding position of the member to be processed, the tape attached to the member to be processed by using a reader, and having the processing device move backwards after the fixing part moves backwards once the tape attached to the member to be processed is recognized.

In addition, the step of checking whether the sampling work for the member to be processed is necessary may be proceeded when the tape connection portion of the member to be processed is not detected in the step of detecting the tape connection portion of the member to be processed. In addition, the method may further include supplying the part to be processed of the member to be processed when the sampling work for the member to be processed is determined to be necessary in the step of determining whether sampling work for the member to be processed is necessary; fixing, when the supply of the part to be processed is completed, the member to be processed by the fixing part; and cutting, by the cutting part, a sampling work area of the part to be processed.

In addition, the method may further include: checking whether attaching a lot sticker to the member to be processed is necessary when the tape work for the member to be processed is determined to be not necessary in the step of determining whether the tape work is necessary for the member to be processed; printing the lot sticker when attaching the lot sticker to the member to be processed is necessary; attaching the lot sticker to the member to be processed; recognizing the lot sticker attached to the member to be processed with a reader, and having the processing device move backwards after the fixing part moves backwards once the lot sticker attached to the member to be processed is recognized.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, by automating processing processes such as cutting or sampling of a member to be processed, it is possible to ensure the reliability of the manufacturing process using the member to be processed.

Furthermore, by increasing accuracy and precision in processing of a member to be processed, it is possible to reduce the defect rate in product manufacturing using the member to be processed.

### BRIEF DESCRIPTION OF THE DRAWINGS

FIG. 1 is a perspective view of a processing device according to an embodiment of the present disclosure.

FIG. 2 is a side view of a processing device according to an embodiment of the present disclosure.

FIGS. 3 to 17 are views sequentially showing the processes of a method for controlling a processing device according to an embodiment of the present disclosure.

FIG. 18 is a perspective view of a semi-finished product roll on which finishing work has been completed by a processing device according to an embodiment of the present disclosure.

FIGS. 19 and 20 are flowcharts showing a method for controlling a processing device according to an embodiment of the present disclosure.

### DETAILED DESCRIPTION OF THE INVENTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

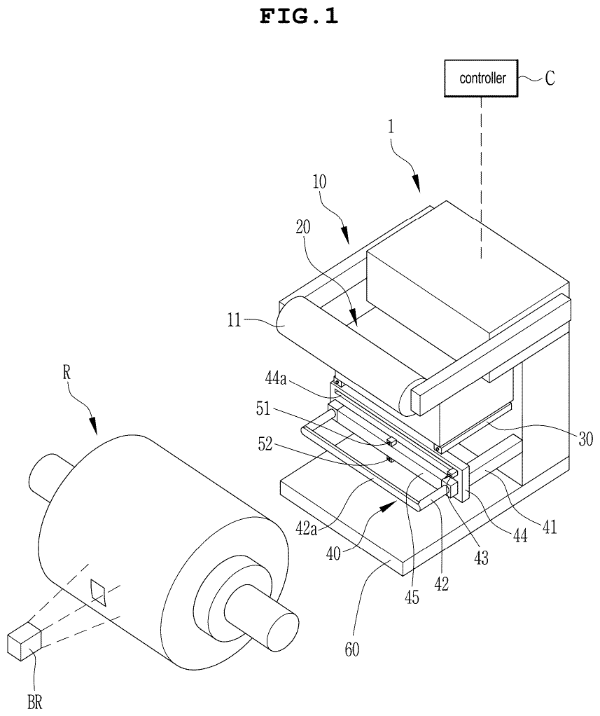

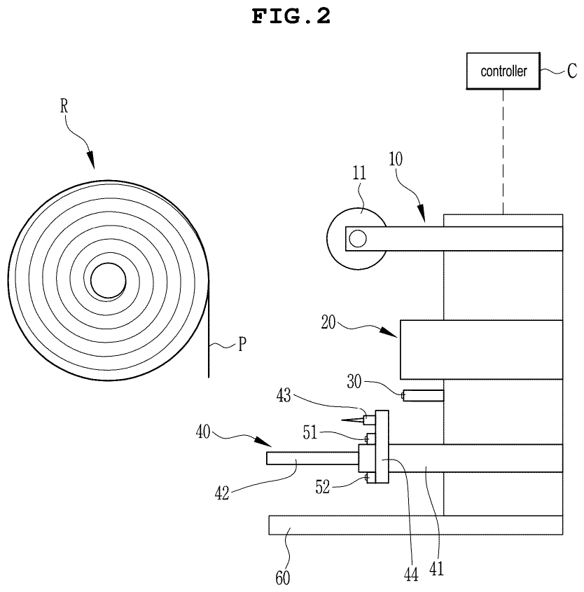

FIG. 1 is a perspective view of a processing device according to an embodiment of the present disclosure, and FIG. 2 is a side view of a processing device according to an embodiment of the present disclosure.

A processing device 1 according to an embodiment of the present disclosure may include: a fixing part 10 that fixes a member to be processed; a marking part 20 that attaches a mark to the member to be processed; a cutting part 40 that cuts the member to be processed to a predetermined length; and a controller C that controls the fixing part 10, the marking part 20, and the cutting part 40 to be individually driven in the forward and backward directions.

In the present disclosure, the member to be processed may include a semi-finished product that requires processing operations at an intermediate stage for product manufacturing or a final product after final product manufacturing. The form of the member to be processed is not limited to a particular shape or structure. For example, the member to be processed may be a wound roll-shaped member with a predetermined width and area, such as an electrode sheet of a secondary battery. In addition, the member to be processed may include products or materials in units that require cutting or sampling of the product or material.

In the present disclosure, the operation and control method of a processing device using a material or product wound in a roll as the member to be processed is shown.

However, the form of the member to be processed to which the processing device may be applied or the method of supplying the member to be processed is not limited to the form or method shown. Thus, the member to be processed to which the processing device according to an embodiment of the present disclosure can be applied may be various products, semi-finished products, or materials.

As shown in FIG. 1, the processing device may be disposed close to a roll-shaped member R to be processed, may move in a direction facing the member R to be processed during processing of the member R to be processed, and may operate the fixing part 10, the marking part 20, and the cutting part 40 individually to perform processing of the member R to be processed.

The fixing part 10 fixes the roll-shaped member R to be processed. The member R to be processed may be a product in the form of a sheet wound in a roll. For example, in the manufacturing process of a secondary battery, a roll-shaped member R to be processed on which an electrode sheet is wound may be included. The member R to be processed on which the sheet-shaped product is wound like this may be manufactured into a final secondary battery by going through processes such as coating or rolling of the electrode sheet. In addition, the processing device 1 according to an embodiment of the present disclosure may be applied for processing or finishing work after a final product is produced.

The marking part 20 may attach a mark to a part P to be processed of the member R to be processed. In this case, the mark includes a barcode or QR code to recognize the product information of the roll-shaped member R to be processed, and may include attaching a tape to prevent the roll from unwinding during the process of finishing the roll-shaped member R to be processed.

The marking part 20 includes a tape supply device therein for attaching a tape and may continuously provide the tape. When attaching a lot sticker L to store and recognize information on the roll-shaped member R to be processed, the lot sticker L may be printed inside the marking part 20 and attached to the roll-shaped member R to be processed. The operating configuration for such tape T supply device or lot sticker L printing may be appropriately designed and applied to the processing device according to an embodiment of the present disclosure.

The cutting part 40 may cut the part P to be processed of the member R to be processed. Examples of cutting the part P to be processed of the member R to be processed include cutting a tape connection portion of the member R to be processed or, if necessary, cutting a portion of the part P to be processed in a predetermined range for sampling work for product inspection of the member R to be processed.

In order for the fixing part 10, the marking part 20, and the cutting part 40 to be individually applied to and operated on the member R to be processed when necessary, the controller C may control each operation of the fixing part 10, the marking part 20, and the cutting part 40 so that the fixing part 10, the marking part 20, and the cutting part 40 are driven in the forward and backward directions facing the member R to be processed. The controller C may be configured as a physical device, or may control the operation of the processing device 1 at a distance or remotely using a wired or wireless device.

As shown in FIG. 2, the physical operating devices of the fixing part 10, marking part 20, and cutting part 40 may be physically spaced apart and coupled to the main body to enable driving in the forward and backward directions.

That is, the fixing part 10 may be coupled to the main body at a position that can be contacted with the member R to be processed, the marking part 20 may be located in a direction facing the member R to be processed and coupled to the main body while being spaced apart from the fixing part 10, and the cutting part 40 may be located in a direction facing the member R to be processed and coupled to the main body while being spaced apart from the marking part 20. The arrangement of each component is not limited to a special structure, and appropriate design changes are possible considering the positions of a fixing area, cutting area, and marking area during processing of the member R to be processed.

That is, in the case of the member R to be processed shown, processing work on the member R to be processed may proceed as follows: the uppermost part of the member R to be processed is fixed by the fixing part 10, the member R to be processed is loosened to allow the supplied part P to be processed to be supplied to the cutting area to the cutting part 40 for the necessary part to be cut, and the marking part 20 is driven to attach a tape to the member R to be processed or to attach the lot sticker L, which is a separate identification tag.

As shown in FIGS. 1 and 2, the fixing part 10 may include a near roll 11 rotatably coupled at one end thereof to contact the member R to be processed and fix the rotation of the roll-shaped member R to be processed.

The near roll 11 may contact the roll-shaped member R to be processed in a stationary state to fix the roll-shaped member R to be processed without loosening. However, by contacting and rotating in the same or opposite direction to the rotation direction of the roll-shaped member R to be processed, appropriate tension may be applied to prevent the fixation of the roll-shaped member R to be processed or the part P to be processed of the roll-shaped member R to be processed from being loosely wound.

The size or material of the near roll 11 is not particularly limited, but it is appropriate to use a material with high friction so that the near roll 11 can be fixed in contact with the roll-shaped member R to be processed. For example, a material such as rubber may be applied.

The processing device 1 according to an embodiment of the present disclosure may include at least one distance sensor 30 that senses the position of the roll-shaped member R to be processed during processing of the member R to be processed. The distance sensor 30 may control and set the appropriate processing position by sensing the distance between the processing device 1 or each component of the processing device 1 and the member R to be processed.

The distance sensor 30 may be coupled to the fixing part 10, marking part 20, and cutting part 40 that operate in the forward and backward directions, but may be coupled to the fixed main body of the processing device 1 to maintain a stable working distance.

In the case of detection sensors 51 and 52, at least one sensor that senses the processing surface of the member R to be processed may be combined. When cutting the tape connection portion of the member R to be processed, the detection sensors 51 and 52 may accurately determine the cutting area when cutting the tape connection portion by detecting the tape connection portion or distinguishing and detecting the surface of the part P to be processed rather than the tape connection portion.

In this way, the cutting area of the part P to be processed supplied as the member R to be processed is released may be accurately determined by means of the detection sensors 51 and 52, so that the cutting part 40 may operate at that position.

As shown in FIG. 2, the detection sensors 51 and 52 may be formed of a first detection sensor 51 coupled to one end of the cutting part 40 and a second detection sensor 52 coupled to the other end of the cutting part 40, and may operate to sense the cutting area of the part P to be processed. However, the coupling position of the detection sensors 51 and 52 is not limited to the specific position shown, and the sensors 51 and 52 may be coupled to an appropriate location of the processing device 1 other than the cutting part 40 for processing of the member R to be processed.

The cutting part 40 may include: a gripper part that secures the part P to be processed supplied while the member R to be processed is released, and a cutter part 43 that cuts a cutting area of the part P to be processed fixed by the gripper part.

To be specific, as shown in FIGS. 1 and 2, the gripper part may include: a pair of cylinder parts 41 disposed at opposite ends of the main body with a separation width greater than the cutting width of the part P to be processed of the member R to be processed; a driving part 42 coupled to the pair of cylinder parts 41 so that a fixing bar 42a coupled in the direction opposite to the cutting width of the part to be processed may be driven in the front and rear directions of the cutting width of the part P to be processed; and a support bar 45 whose opposite ends are respectively coupled to the cylinder parts 41 to secure the part P to be processed located between the fixing bar 42a and the support bar 45.

The cylinder parts 41 may be respectively provided at opposite ends of the main body in the width direction with the separation width greater than the width of the part P to be processed. The driving part 42 is inserted into the pair of cylinder parts 41 and driven forward and backward, and the fixing bar 42a is coupled to one end of the driving part 42 in the width direction of the part P to be processed in a direction perpendicular to the driving direction.

The fixing bar 42a may be driven in the direction of the cylinder parts 41 to adjust the gap in the direction facing the support bar 45 connecting opposite ends of the pair of cylinder parts 41, and the part P to be processed may be fixed in close contact between them fixing bar 42a and the support bar 45.

Each contact surface of the fixing bar 42a and the support bar 45 may be formed into a surface or shape with high friction, such as a rubber member or an uneven part on order to closely fix the part P to be processed between the fixing bar 42a and the support bar 45.

The support bar 45 is not limited to the form of the bar-shaped square pillar shown in FIG. 1, and various forms may be applied as long as the fixing bar 42a comes into close contact with the support bar 45 by driving to fix the part P to be processed therebetween.

The cutting part 40 may include: a cutter coupling part 44 coupled to correspond to the cutting width of the part P to be processed; and a cutter part 43 coupled to a guide rail 44a provided on the cutter coupling part 44 along the cutting width of the part P to be processed to cut the part P to be processed.

The cutter coupling part 44 may form the guide rail 44a on which the cutter part 43 can move so as to cut the part P to be processed while driving in the width direction of the part P to be processed. The method of driving the cutter part 43 to cut the part P to be processed in the width direction in the cutter coupling part 44 is not limited to the guide rail 44a shown.

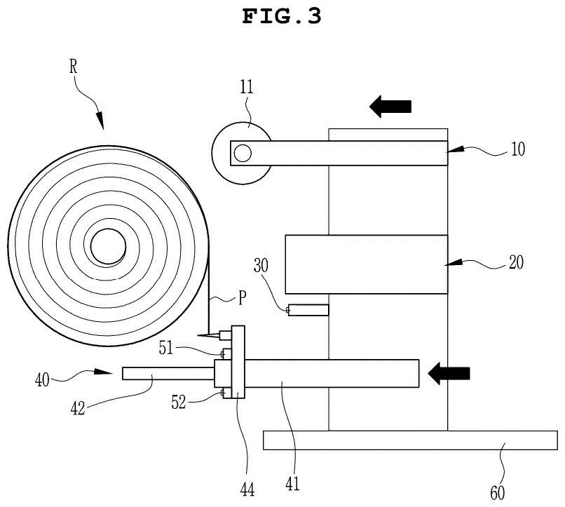

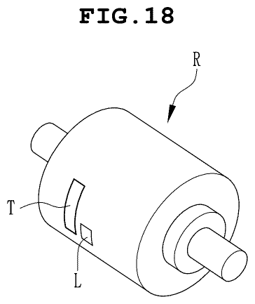

FIGS. 3 to 17 are views sequentially showing the processes of a method for controlling a processing device according to an embodiment of the present disclosure, and FIG. 18 is a perspective view of a roll-shaped member to be processed on which processing work has been completed by a processing device according to an embodiment of the present disclosure.

The method for controlling the processing device 1 according to an embodiment of the present disclosure may include: detecting a tape connection portion of a member R to be processed; supplying a part to be processed including the tape connection portion of the member to be processed when the tape connection portion of the member to be processed is detected; fixing, by the fixing part, the member to be processed when the supply of the part to be processed is completed; and cutting, by the cutting part, the tape connection portion of the part to be processed.

First, the step of detecting the tape connection portion of the member R to be processed is explained.

As shown in FIG. 3, for processing of the member R to be processed, the processing device 1 approaches the member R to be processed and detects the tape connection portion of the member R to be processed. The tape connection portion may be removed during processing of the roll-shaped member R to be processed, and the member R to be processed may be passed on to the next manufacturing process or the final manufacturing process may be completed.

The processing device 1 approaches the member R to be processed at a workable distance by means of the distance sensor 30, and detects the tape connection portion of the processing surface of the part P to be processed by means of the detection sensors 51 and 52.

At this time, the processing device 1 drives the entire device forward and backward with respect to the member R to be processed based on a LM guide 60, so that processing work on the member R to be processed and work such as replacing the member R to be processed may proceed more smoothly. However, the illustrated LM guide 60 is only a specific example, and may include an appropriate guide capable of having the same function and operation.

Next step is to supply the part P to be processed including the tape connection portion of the member R to be processed when the tape connection portion of the roll-shaped member R to be processed is detected.

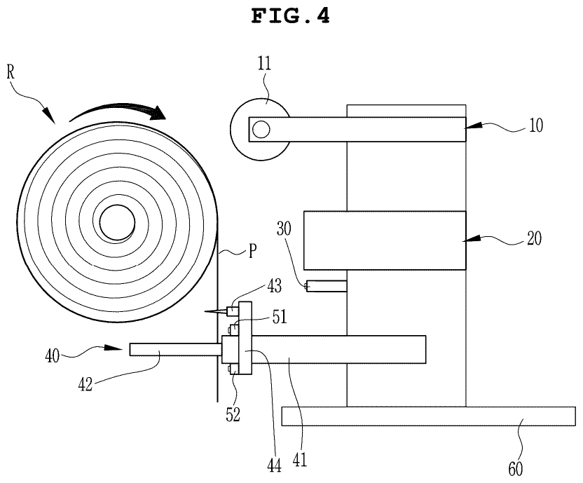

As shown in FIG. 4, when the member R to be processed is in the form of a roll, the roll may be unwound and the part P to be processed may be naturally supplied to the processing device 1. If necessary, the processing work may be started by supplying the part P to be processed of the member R to be processed to the processing device 1 by using an additional device.

That is, when the tape connection portion of the member R to be processed is detected, the roll-shaped member R to be processed is unwound and the tape connection portion of the part P to be processed is prepared to be cut. At this time, for the member R to be processed to be unwound, the fixing part 10 is not in contact with the member R to be processed, or operates to move backward if the fixing part 10 is in contact with the member R to be processed.

When the tape connection portion of the member R to be processed is not detected, the cutting process of the tape connection portion of the member R to be processed is skipped, and the process may proceed directly to the step of checking whether the sampling work for the member R to be processed is performed.

Next, when the supply of the part P to be processed is completed, the step of fixing the member R to be processed by the fixing part is performed.

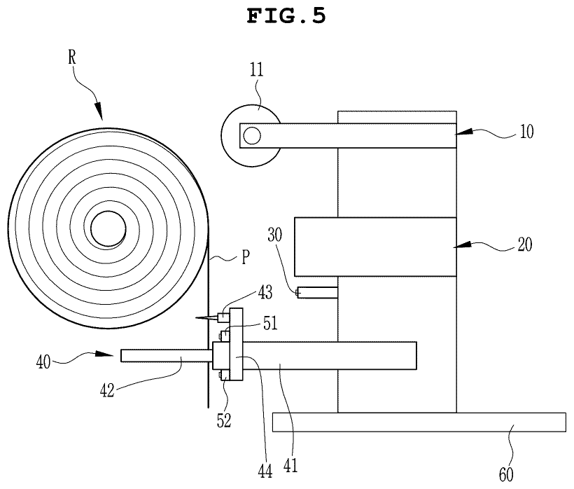

As shown in FIG. 5, after the roll of the roll-shaped member R to be processed is unwound and the part P to be processed is supplied for a predetermined length, the roll of the member R to be processed is stopped to stop the supply of the part P to be processed. In this case, regarding the predetermined length to which the part P to be processed is supplied, the supply of the member R to be processed may be adjusted and controlled so that the tape connection portion is supplied to an appropriate position for cutting as the processing surface of the part P to be processed is detected by the detection sensor.

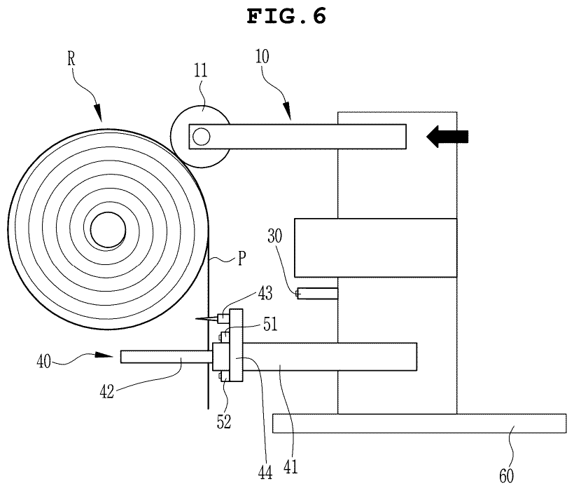

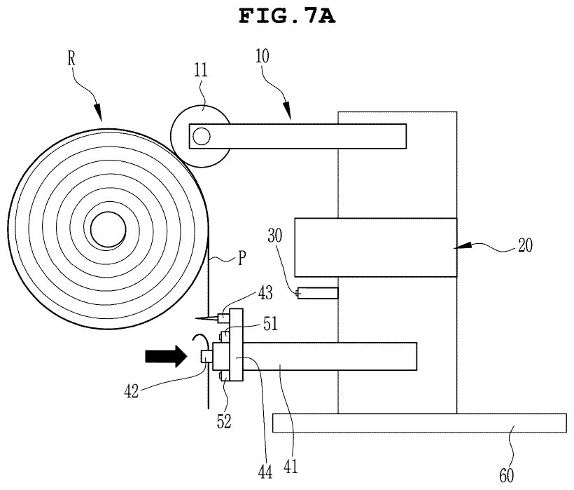

As shown in FIG. 6, the fixing part 10 is driven to approach the member R to be processed and contacts a surface of the member R to be processed, causing the member R to be processed to stop supplying the part P to be processed. In other words, the roll may be controlled so as not to unwind any longer.

Next is the step where the cutting part 40 cuts the tape connection portion of the part P to be processed.

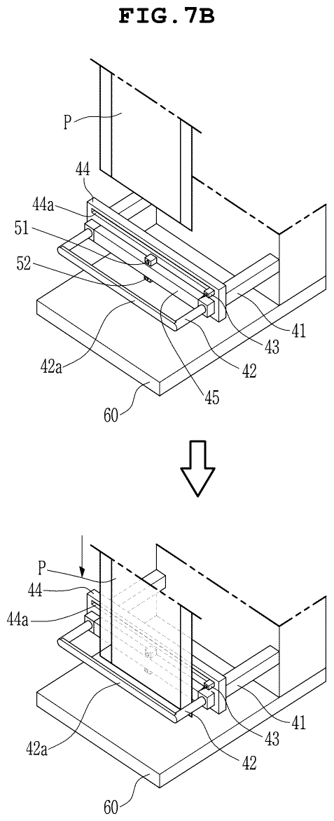

As shown in FIG. 7A, this is a step in which the cutting part 40 cuts the tape connection portion of the part P to be processed after the part P to be processed is extended downward and fixed to a predetermined length.

To be specific, as shown in FIG. 7B, the gripper part of the cutting part 40 may fix the part P to be processed at the cutting position. That is, the gripper part has the driving part 42 provided with the fixing bar 42a that drives forward and backward from the cylinder parts 41 at opposite ends of the main body, and may accommodate the part P to be processed in the inward direction of the processing device 1.

That is, after the driving part 42 of the gripper part moves forward, the part P to be processed may be inserted inward between the fixing bar 42a and the support bar 45 of the driving part 42.

Then, as shown in FIG. 7C, while the part P to be processed inserted inside the fixing part 10 is driven by the driving part 42 in a direction in which the fixing bar 42a approaches the inside of the cylinder parts 41 and the support bar 45, the part P to be processed may be tightly fixed between the fixing bar 42a and the support bar 45.

Then, the cutter part 43 driven along the guide rail 44a in the width direction of the part P to be processed cuts the tape connection portion of the part P to be processed in the width direction. In this way, the cutting work is completed by cutting the tape connection portion of the part P to be processed.

The next step is to check whether sampling work for the roll-shaped member R to be processed is performed.

After cutting the tape connection portion of the member R to be processed, in the case where a separate reliability test for the member R to be processed is required, it is necessary to cut out the required length from the member R to be processed to extract a sample of a predetermined length.

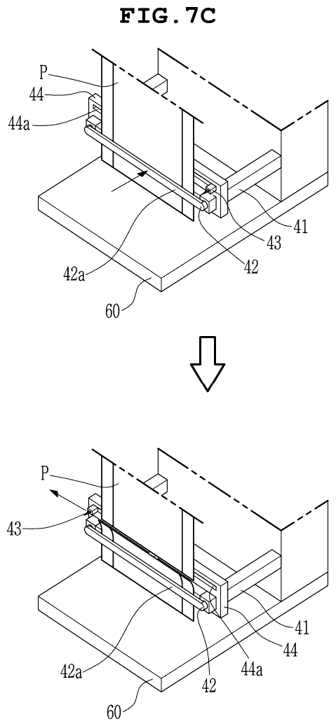

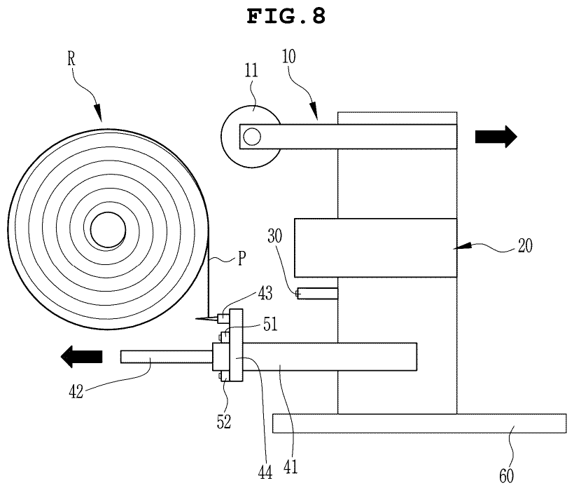

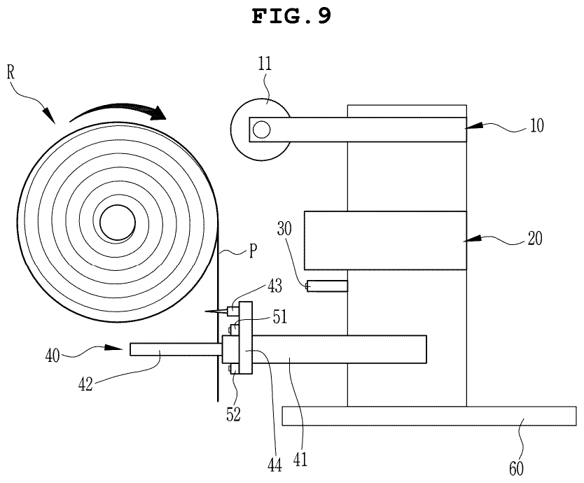

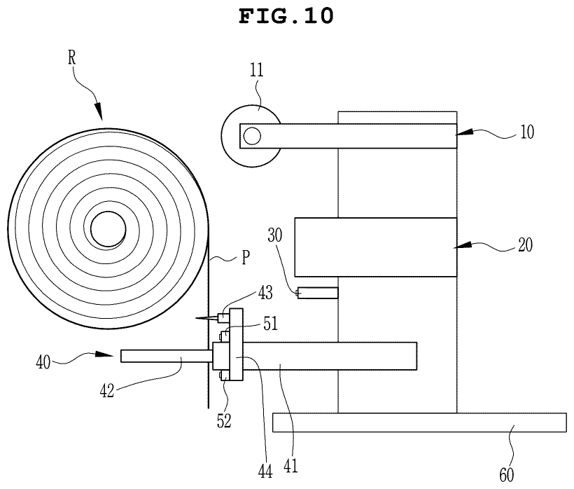

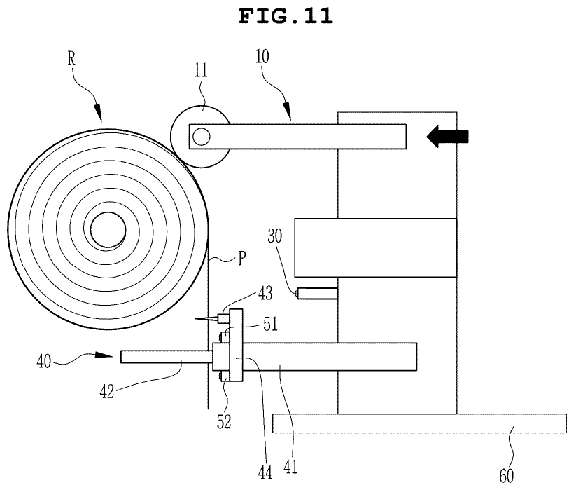

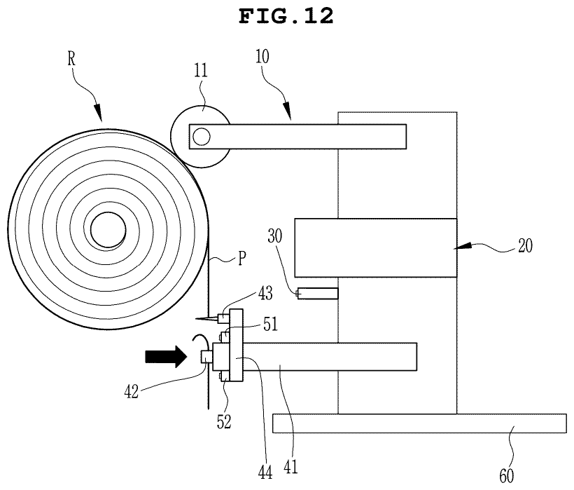

In this case, as described above, the following steps may occur: the fixing part 10 moves away from the roll-shaped member R to be processed, the cutting part 40 moves closer for work, and the member R to be processed rotates to unwind and supply the part P to be processed to a predetermined length as shown in FIGS. 8 and 9; and when the supply of the part P to be processed is completed and the member R to be processed is stopped to stop the supply of the part P to be processed as shown in FIG. 10, the fixing part 10 fixes the member R to be processed as shown in FIG. 11, and the cutting part 40 cuts the sampling work area of the part P to be processed as shown in FIG. 12.

That is, in the same manner as the step of cutting the tape connection portion of the member R to be processed, the step of cutting the part P to be processed of the required range to a predetermined length may be performed repeatedly as many units as required for sampling.

When sampling work for the roll-shaped member R to be processed is not necessary, the member R to be processed rotates to wind up the part P to be processed that has been cut and processed, and then the fixing part 10 fixes the member R to be processed.

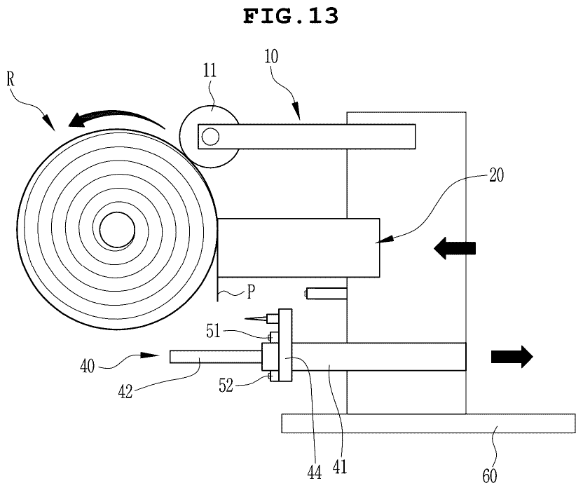

As shown in FIG. 13, when the member R to be processed is fixed by the fixing part 10, the cutting part 40 may move backwards and withdraw from the member R to be processed, and the marking part 20 may be driven in a direction approaching the member R to be processed. This is to determine whether to perform tape work or attach the lot sticker L to the part P to be processed later and prepare for the corresponding work.

The next step is to determine whether to use tape on the member R to be processed.

At this stage, it is decided whether to complete the work on the roll-shaped member R to be processed by attaching a tape to the roll-shaped member R to be processed after cutting the tape connection portion of the member R to be processed and performing sampling work if sampling work is necessary.

When the tape T work is required for the member R to be processed, the marking part 20 performs a step of attaching the tape T to the corresponding position of the roll-shaped member R to be processed.

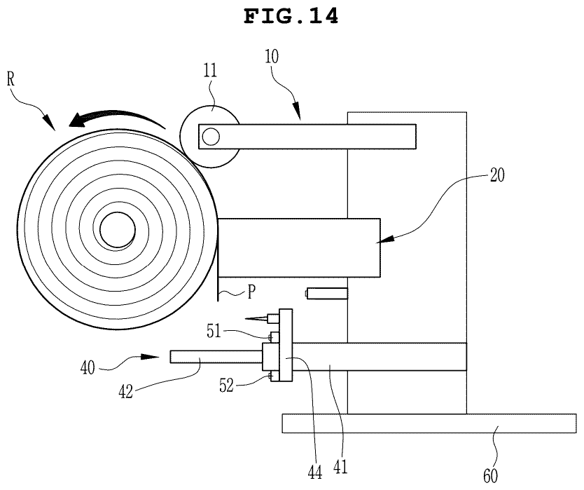

As shown in FIG. 14, if attaching the tape T to the member R to be processed is necessary, after the part P to be processed is properly wound, the marking part 20 attaches the tape to the corresponding position.

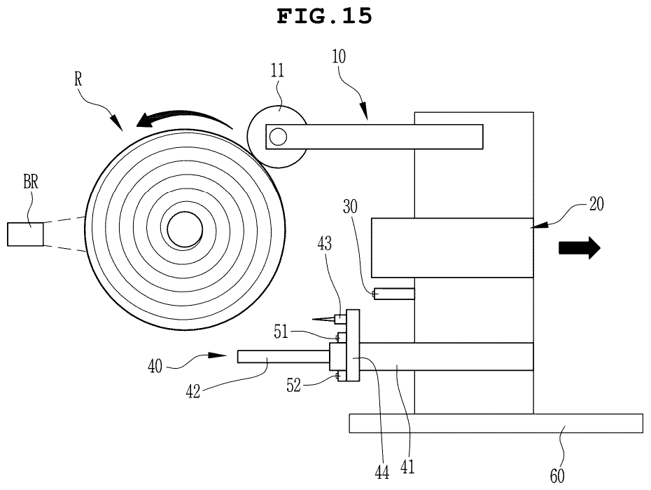

Next, as shown in FIG. 15, by performing the step of recognizing the tape T attached to the member R to be processed with a reader BR or a recognition sensor, it can be confirmed whether the tape is attached to the member R to be processed.

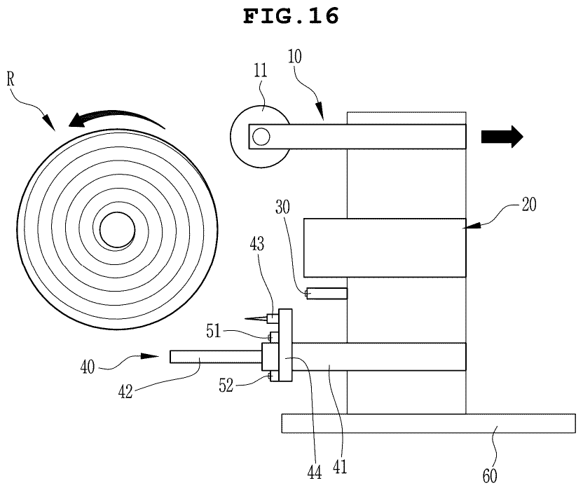

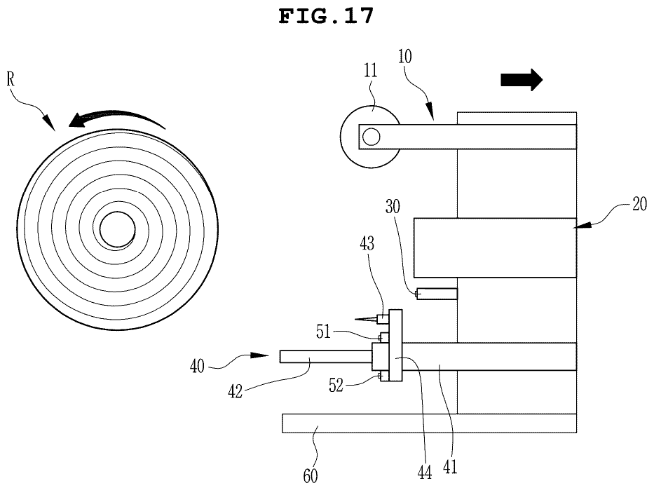

Next, once the tape attached to the member R to be processed is recognized, after the fixing part 10 moves backwards as shown in FIG. 16, the processing device 1 moves backwards as shown in FIG. 17, thereby completing the processing of the member R to be processed.

Finally, as shown in FIG. 18, the processing of the member R to be processed, in which the tape T is attached to the roll-shaped member R to be processed, is completed.

If attaching a tape to the member R to be processed is determined to be not necessary in the step of determining whether to use tape on the member R to be processed, a step of determining whether to attach the lot sticker L to the member R to be processed may be performed.

In this case as well, as shown in FIG. 14, when the lot sticker L is required for the member R to be processed, the marking part 20 may output the lot sticker L and attach the lot sticker L to the member R to be processed.

In this case, the lot sticker L is a mark for recognizing various information on the member R to be processed, and may include a barcode, a QR code, etc.

The next step is to recognize the lot sticker L attached to the roll-shaped member R to be processed with the reader BR as shown in FIG. 15. Through this step, it can be confirmed whether the lot sticker L is accurately attached to the roll-shaped member R to be processed.

Next, once the lot sticker L on the member R to be processed is recognized, after the fixing part 10 moves backwards as shown in FIG. 16, the processing device 1 moves backwards as shown in FIG. 17, thereby completing the processing of the member R to be processed.

Finally, as shown in FIG. 18, the member R to be processed, in which the lot sticker L is attached to the roll-shaped member R to be processed, may be manufactured.

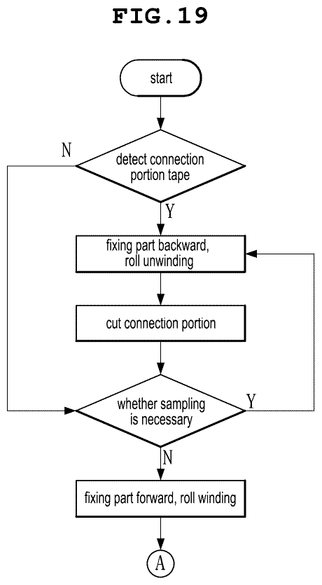

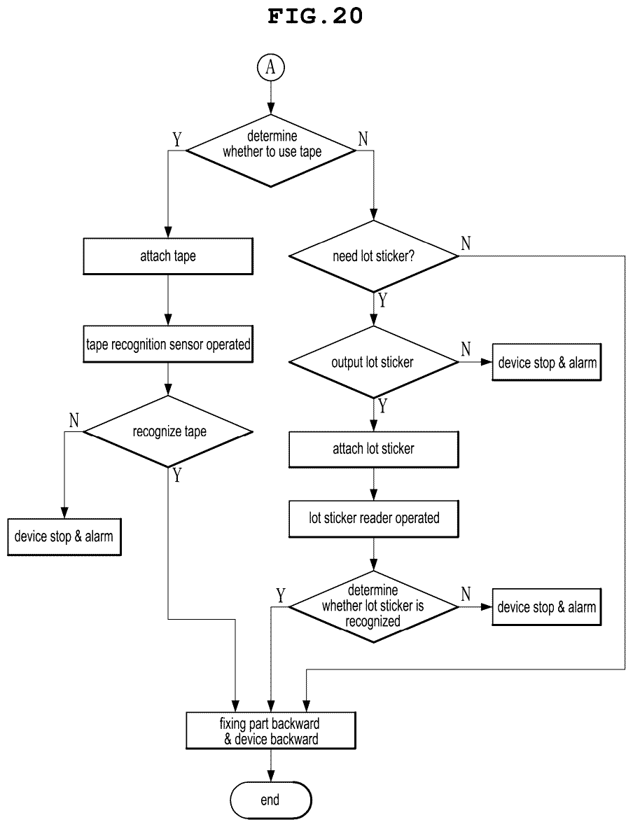

FIGS. 19 and 20 are flowcharts showing a method for controlling a processing device according to an embodiment of the present disclosure.

The process in the flowcharts showing the method for controlling the processing device 1 from FIG. 19 to FIG. 20 is explained as follows.

First, the tape connection portion of the member R to be processed is detected. The tape connection portion may be detected by means of the detection sensors 51 and 52 of the processing device 1.

When the tape connection portion of the member R to be processed is detected, the fixing part 10 moves backwards, so that the member R to be processed is unwound and the part P to be processed may be supplied. The member R to be processed may be controlled to unwind the roll appropriately so that the part P to be processed is supplied to a predetermined length for cutting of the tape connection portion.

Next, when the part P to be processed including the tape connection portion is supplied and fixed at the cutting part 40, the tape connection portion is cut by the cutting part 40.

Next, in addition to cutting the tape connection portion, when sampling work is required to check the condition of the part P to be processed of the member R to be processed or other inspections, the roll may be unwound to supply the part P to be processed of a predetermined length by rotating the member R to be processed, and sampling work may be performed by cutting the required length by means of the cutting part 40.

When sampling work for the member R to be processed is not necessary, the process may be proceeded by advancing the fixing part 10 and winding the roll as necessary to determine whether to proceed to the next step with the member R to be processed fixed.

Next, whether tape attachment work is necessary for processing the member R to be processed is determined. In this case, when tape attachment work is necessary, the marking part 20 may approach and attach the tape to a predetermined position on the member R to be processed.

After attaching the tape to the member R to be processed, when it is confirmed that the attached tape is recognized by means of the reader BR or the tape recognition sensor, the fixing part 10 moves backwards, and the entire processing device 1 moves backwards to complete the processing of the member R to be processed.

However, in the case where the tape attached to the member R to be processed is not recognized, the equipment may be stopped, an alarm may be sounded, and an operator or the controller C may instruct modification of the work or terminate the work.

When the tape work on the member R to be processed is completed or when the tape attachment work on the member R to be processed is not necessary, whether the lot sticker L is attached to the member R to be processed may be confirmed.

The lot sticker L may be used to recognize various information, such as product information or specifications of the member R to be processed to select and perform the necessary processes later, or store and display final product information. A barcode or QR code may be used as the lot sticker L.

When the lot sticker L is necessary, the marking part 20 outputs the lot sticker L using a lot sticker L supply device (not shown) and attaches the lot sticker L to the member R to be processed. In the case where the lot sticker L supply device does not operate, the relevant equipment may be stopped and an alarm may be sounded so that corrections may be made by an external operator or separate corrections may be performed by the controller C. Even in this case, the corresponding work may be stopped or terminated.

Once the lot sticker L is attached to the member R to be processed, whether the lot sticker L is attached is determined using the reader BR capable of recognizing the lot sticker L. When the lot sticker L is recognized normally, the work may be completed by retracting and withdrawing the fixing part 10 from the member R to be processed and retracting and withdrawing the entire processing device 1.

On the other hand, when the lot sticker L of the member R to be processed is not recognized properly, the relevant equipment may be stopped and an alarm may be sounded so that corrections may be made by an external operator or separate corrections may be performed by the controller C.

However, although the method for controlling the processing device 1 according to the flowcharts shown in FIGS. 19 and 20 has been described, this does not limit or limit the interpretation of the method for controlling the processing device 1 previously described, and all of the methods may be included and applied in the present disclosure to the extent that they do not conflict with each other.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A processing device comprising:
a fixing part configured to fix a member to be processed;
a marking part configured to attach a mark to the member to be processed;
a cutting part configured to cut the member to be processed to a predetermined length; and
a controller configured to control the fixing part, the marking part, and the cutting part to be individually driven in forward and backward directions.

2. The device of claim 1, wherein the fixing part is coupled to a main body of the device at a position that is contactable with the member to be processed,
the marking part is located in a direction facing the member to be processed and coupled to the main body while being spaced apart from the fixing part, and
the cutting part is located in the direction facing the member to be processed and coupled to the main body while being spaced apart from the marking part.

3. The device of claim 1, wherein the fixing part is provided with a near roll rotatably coupled at an end thereof to contact the member to be processed and fix the member to be processed.

4. The device of claim 1, further comprising:
at least one distance sensor configured to sense a position of the member to be processed.

5. The device of claim 1, further comprising:
at least one detection sensor configured to sense a processing surface of the member to be processed.

6. The device of claim 5, wherein the at least one detection sensor comprises:
a first detection sensor coupled to a first end of the cutting part; and
a second detection sensor coupled to a second end of the cutting part.

7. The device of claim 1, wherein the cutting part comprises:
a gripper part configured to fix a part to be processed of the member to be processed; and
a cutter part configured to cut a cutting area of the part to be processed fixed by the gripper part.

8. The device of claim 7, wherein the gripper part comprises:
a pair of cylinder parts disposed at opposite ends of a main body of the device with a separation width greater than a cutting width of the part to be processed of the member to be processed;
a driving part coupled to the pair of cylinder parts so that a fixing bar coupled in a direction opposite to the cutting width of the part to be processed is driven in front and rear directions of the cutting width of the part to be processed; and
a support bar whose opposite ends are respectively coupled to the cylinder parts to secure the part to be processed located between the fixing bar and the support bar.

9. The device of claim 7, wherein the cutting part comprises:
a cutter coupling part coupled to correspond to the cutting width of the part to be processed; and
a cutter part coupled to a guide rail provided on the cutter coupling part along the cutting width of the part to be processed to cut the part to be processed.

10. A method for controlling a processing device, the method comprising:
detecting a tape connection portion of a member to be processed;
supplying, when the tape connection portion of the member to be processed is detected, a part to be processed including the tape connection portion of the member to be processed;
fixing, by the fixing part, the member to be processed when the supply of the part to be processed is completed; and
cutting, by the cutting part, the tape connection portion of the part to be processed.

11. The method of claim 10, further comprising:
checking, after the step of cutting, by the cutting part, the tape connection portion of the part to be processed of the member to be processed, whether sampling work for the member to be processed is necessary;
fixing, by the fixing part, the member to be processed when the sampling work for the member to be processed is not necessary;
determining whether tape work is necessary for the member to be processed; and
attaching, by the marking part, a tape to a corresponding position of the member to be processed when the tape work is necessary for the member to be processed.

12. The method of claim 11, further comprising:
recognizing, after the step of attaching the tape by the marking part to the corresponding position of the member to be processed, the tape attached to the member to be processed by using a reader; and
having the processing device move backwards after the fixing part moves backwards once the tape attached to the member to be processed is recognized.

13. The method of claim 11, wherein the step of checking whether the sampling work for the member to be processed is necessary is proceeded when the tape connection portion of the member to be processed is not detected in the step of detecting the tape connection portion of the member to be processed.

14. The method of claim 11, further comprising:
supplying the part to be processed of the member to be processed when the sampling work for the member to be processed is determined to be necessary in the step of determining whether sampling work for the member to be processed is necessary;
fixing, when the supply of the part to be processed is completed, the member to be processed by the fixing part; and
cutting, by the cutting part, a sampling work area of the part to be processed.

15. The method of claim 11, further comprising:
checking whether attaching a lot sticker to the member to be processed is necessary when the tape work for the member to be processed is determined to be not necessary in the step of determining whether the tape work is necessary for the member to be processed;
printing the lot sticker when attaching the lot sticker to the member to be processed is necessary;
attaching the lot sticker to the member to be processed;
recognizing the lot sticker attached to the member to be processed with a reader, and
having the processing device move backwards after the fixing part moves backwards once the lot sticker attached to the member to be processed is recognized.
